(19) United States
(12) Patent Application Publication
(10) Pub. No.: US 2025/0341345 A1
(43) Pub. Date: Nov. 6, 2025

(54) MULTI-STAGE ROTOR FOR AIR CYCLE MACHINE

(71) Applicant: Hamilton Sundstrand Corporation, Charlotte, NC (US)

(72) Inventors: Zachary Alex Schuster, Chicago, IL (US); John Giuliano, North Granby, CT (US); Viktor Kilchyk, Lancaster, NY (US); Jeremy Clavette, Farmington, CT (US)

(21) Appl. No.: 18/655,691

(22) Filed: May 6, 2024

(51) Int. Cl. F25B 9/06; F25B 9/00; F25B 9/10

(52) U.S. Cl. CPC F25B 9/06; F25B 9/004; F25B 9/10

(57) ABSTRACT

A single shaft, one piece rotor having: a hub that extends from a hub aft end to a hub forward end, wherein the hub aft end defines a first diameter and the hub forward end defines a second diameter that is smaller than the first diameter; a plurality of blade stages extending from a forward end to an aft end, wherein the blade stages are stacked, one on top of the other, radially outwardly from the hub, including an inner stage that is integral with the hub and an outer stage that is radially spaced apart from the hub; and a shroud between adjacent ones of the blade stages.

### BACKGROUND

The embodiments are directed to air cycle machines and more specifically to a multi-stage rotor for an air cycle machine.

An air cycle machine (ACM) serves as the refrigeration unit within the environmental control system (ECS) of pressurized gas turbine-powered aircraft. Typically, an aircraft has two or three ACMs. Each ACM, along with its components, is often referred to as an air conditioning pack. Hot bleed air from the aircraft's engines, auxiliary power unit (APU), or a ground source, which can be at high temperatures and pressures, is directed into a primary heat exchanger. The primary heat exchanger uses ambient outside air as the coolant. The hot bleed air is then compressed by a centrifugal compressor. After compression, the air is sent to a secondary heat exchanger, where it is again cooled using outside air as the coolant. Pre-cooling through the first heat exchanger improves efficiency by lowering the temperature of the air entering the compressor. The compressed, cooled air then passes through an expansion turbine. As the air expands, it cools to below ambient temperature. The work extracted by the expansion turbine is transmitted via a shaft to spin the centrifugal compressor of the pack and an inlet fan. The inlet fan draws in external air for the heat exchangers during ground running, while RAM air is used in flight. The ACM provides cooled air directly for cabin ventilation or for cooling electronic equipment on board.

In a typical ACM, the number of rotary components, i.e., the compressor and one or more turbines, may occupy a significant amount of space on an aircraft, which may be undesirable.

### BRIEF DESCRIPTION

A single shaft, one piece rotor including: a hub that extends from a hub aft end to a hub forward end, wherein the hub aft end defines a first diameter and the hub forward end defines a second diameter that is smaller than the first diameter; a plurality of blade stages extending from a forward end to an aft end, wherein the blade stages are stacked, one on top of the other, radially outwardly from the hub, including an inner stage that is integral with the hub and an outer stage that is radially spaced apart from the hub; and a shroud between adjacent ones of the blade stages.

In addition to one or more aspects of the rotor, or as an alternate, the rotor is additively manufactured.

In addition to one or more aspects of the rotor, or as an alternate, the rotor includes a plurality of the shrouds, wherein each one of the blade stages is surrounded by a corresponding one of the shrouds, such that there is at least an inner shroud surrounding the inner stage, and an outer shroud surrounding the outer stage.

In addition to one or more aspects of the rotor, or as an alternate, the hub and shrouds are each bell shaped.

In addition to one or more aspects of the rotor, or as an alternate, each of the blade stages defines a flow path having a flow area that increases towards the forward end of the hub.

In addition to one or more aspects of the rotor, or as an alternate, each of the shrouds extends from an aft end to a forward end; the aft end of the inner shroud is axially forward of the hub aft end; and the aft end of each successively exterior one of the shrouds is axially forward of the adjacent one of the shrouds, whereby a flow path along each of the blade stages is radial at the aft end of the hub and axial at the forward and of the hub.

In addition to one or more aspects of the rotor, or as an alternate, the hub defines an axial center channel for rotationally securing the hub to a housing.

A rotor assembly including, a rotor having one or more of the above disclosed aspects, wherein the rotor is a two-stage rotor, wherein the inner stage extends from an inner stage forward end to an inner stage aft end and the outer stage extends from an outer stage forward end to an outer stage aft end; and a housing in which the rotor is encased, wherein the housing extends from a forward end to an aft end, wherein: the forward end of the housing defines a forward inner nozzle and a forward inner passage that abut the forward end of the inner stage, and a forward outer nozzle and a forward outer passage that abut the forward end of the outer stage; and the aft end of the housing defines an aft inner nozzle and an aft inner passage that abut the aft end of the inner stage, and an aft outer nozzle and an aft outer passage that abut the aft end of the outer stage.

In addition to one or more aspects of the rotor assembly, or as an alternate, the housing is defined by a unitary forward housing portion and a unitary aft portion housing portion, wherein: the forward housing portion and covers the forward end of the outer stage, and extends axially forward of the inner stage to define: the forward inner nozzle, the forward inner passage, the forward outer nozzle, and the forward outer passage; and the aft housing portion covers the aft end of each of the blade stages and the aft end of the hub and defines the aft inner nozzle, the aft inner passage, the aft outer nozzle, and the aft outer passage.

In addition to one or more aspects of the rotor assembly, or as an alternate, the housing is additively manufactured.

In addition to one or more aspects of the rotor assembly, or as an alternate, each of the passages of the housing defines an annulus and the passages are layered against the housing or each other to define a close-packed shape.

An air cycle machine including: a rotor assembly having one or more of the above disclosed aspects; an air conduit; primary and secondary heat exchangers coupled to the air conduit, wherein: the primary heat exchanger has an outlet coupled to the forward outer nozzle of the outer stage of the rotor assembly; the secondary heat exchanger has an inlet coupled to the aft outer nozzle of the outer stage of the rotor assembly, and an outlet coupled to the aft inner nozzle of the inner stage of the rotor assembly, whereby the outer stage is a compressor stage and the inner stage is a turbine stage.

In addition to one or more aspects of the air cycle machine, or as an alternate, the air cycle machine includes a fan disposed in the air conduit, downstream of the primary and secondary heat exchangers, wherein the forward end of the hub is connected to the fan via a shaft.

Another embodiment of the rotor assembly, including a rotor having one or more of the above disclosed aspects, wherein the rotor is a three-stage rotor having: the inner stage that extends from an inner stage forward end to an inner stage aft end, the outer stage that extends from an outer stage forward end to an outer stage aft end, and an intermediate stage that extends from an intermediate stage forward end to an intermediate stage aft end; and the shroud is an inner shroud surrounding the inner stage, and an intermediate shroud surrounds the intermediate stage; and wherein the assembly includes: a housing in which the rotor is encased, wherein the housing extends from a forward end to an aft end, wherein: the forward end defines a forward inner nozzle and a forward inner passage that abut the forward end of the inner stage, a forward outer nozzle and a forward outer passage that abut the forward end of the outer stage, and a forward intermediate nozzle and a forward intermediate passage that abut the forward end of the intermediate stage; and the aft end defines an aft inner nozzle and an aft inner passage that abut the aft end of the inner stage, an aft outer nozzle and an aft outer passage that abut the aft end of the outer stage, and an aft intermediate nozzle and an aft intermediate passage that abut the aft end of the intermediate stage.

In addition to one or more aspects of the another embodiment of the rotor assembly, or as an alternate, the housing is defined by a unitary forward housing portion and a unitary aft portion housing portion; the forward housing portion covers the forward end of the outer stage, and extends axially forward of the inner stage to define the forward inner nozzle, the forward inner passage, the forward outer nozzle, the forward outer passage, the forward intermediate nozzle, and the forward intermediate passage; and the aft housing portion covers the aft end of each of the blade stages and the aft end of the hub and defines the aft inner nozzle, the aft inner passage, the aft outer nozzle, the aft outer passage, the aft intermediate nozzle, and the aft intermediate passage.

In addition to one or more aspects of the another embodiment of the rotor assembly, or as an alternate, the housing is additively manufactured, and the passages are positioned against the housing to define a close-packed shape.

In addition to one or more aspects of the another embodiment of the rotor assembly, or as an alternate, each of the passages of the housing defines an annulus and the passages are layered against the housing or each other to define a close-packed shape.

Another embodiment of the air cycle machine including: the another embodiment of the rotor assembly having one or more of the above aspects; an air conduit; primary and secondary heat exchangers coupled to the air conduit, wherein: the primary heat exchanger has an outlet coupled to the forward outer nozzle of the outer stage of the rotor assembly; and the secondary heat exchanger has: an inlet coupled to the aft outer nozzle of the outer stage of the rotor assembly; and an outlet coupled to the aft intermediate nozzle of the intermediate stage of the rotor assembly, wherein the forward intermediate nozzle for the intermediate stage of the rotor assembly is coupled to the aft inner nozzle of the inner stage of the rotor assembly, whereby the outer stage is a compressor stage and the intermediate and inner stages are turbine stages.

In addition to one or more aspects of the another embodiment of the air cycle machine or as an alternate, the air cycle machine includes a fan disposed in the air conduit, downstream of the primary and secondary heat exchangers, wherein the forward end of the hub is connected to the fan via a shaft.

In addition to one or more aspects of the rotor, or as an alternate, the rotor is a two stage rotor that includes the inner and outer stages, wherein: the inner and outer stages are turbine stages; or the inner stage is a compressor stage and the outer stage is a turbine stage; or the inner stage is the turbine stage and the outer stage is the compressor stage; or the rotor is a three stage rotor that includes the inner and outer stages and an intermediate stage, wherein: the inner stage is the compressor stage and the intermediate and outer stages are the turbine stages; or the inner and outer stages are the turbine stages and the intermediate stage is the compressor stage; or the inner and intermediate stages are the turbine stages and the outer stage is the compressor stage.

### BRIEF DESCRIPTION OF THE DRAWINGS

The following descriptions should not be considered limiting in any way. With reference to the accompanying drawings, like elements are numbered alike:

FIG. 1 shows a single shaft, one piece rotor according to an embodiment;

FIG. 2 shows a rotor assembly according to an embodiment, including the rotor of FIG. 1, in a housing;

FIG. 3 shows an air cycle machine according to an embodiment, including the rotor assembly of FIG. 2;

FIG. 4 shows a single shaft, one piece rotor according to another embodiment;

FIG. 5 shows a rotor assembly according to another embodiment, including the rotor of FIG. 4, in a housing; and

FIG. 6 shows an air cycle machine according to another embodiment, including the rotor assembly of FIG. 5.

### DETAILED DESCRIPTION

A detailed description of one or more embodiments of the disclosed apparatus are presented herein by way of exemplification and not limitation with reference to the Figures.

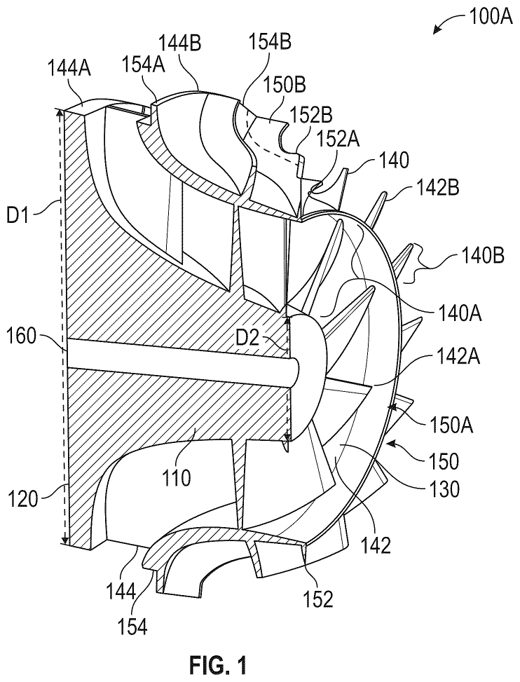

Turning to FIG. 1, a single shaft, one piece rotor 100A is disclosed. In one embodiment, the rotor 100A is additively manufactured. The rotor 100A has a hub 110 that extends from a hub aft end 120 to a hub forward end 130. The hub aft end 120 defines a first diameter D1 and the hub forward end 130 defines a second diameter D2 that is smaller than the first diameter D1.

The rotor 100A includes a plurality of blade stages 140 extending from a stage forward end 142 to a stage aft end 144. The blades may be oriented axially, radially or a hybrid of each. The blade stages 140 are stacked, one on top of the other, radially outwardly from the hub 110. The rotor of FIG. 1 is a two-stage rotor. An inner stage 140A is integral with the hub 110 and extends axially from an inner stage forward end 142A to an inner stage aft end 144A. An outer stage 140B is radially spaced apart from the hub and extends from an outer stage forward end 142B to an outer stage aft end 144B. A shroud 150A (or inner shroud; generally referenced as 150) is between adjacent ones of the blade stages 140 and extends from shroud forward to aft ends 152A, 154A.

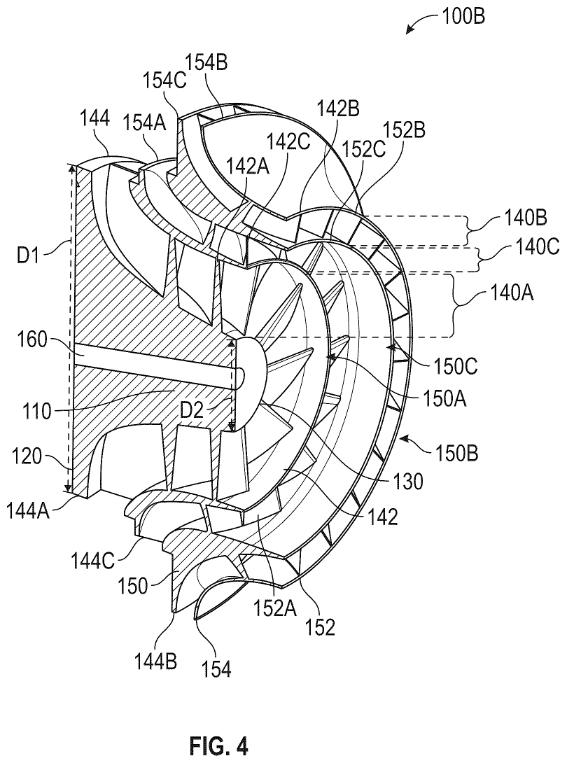

In one embodiment, each stage is covered by a respective shroud (discussed in greater detail, below, with the disclosure related to FIG. 4). For example, the outer stage 140B may be covered by an outer shroud 150B, shown schematically, which extends from forward to aft ends 152B, 154B. In one embodiment, the hub 110 and shroud 150A are each thermally insulated. In one embodiment, the hub 110 and shroud 150A are each bell shaped. In one embodiment, each of the blade stages 140 defines a flow path having a flow area that increases towards the forward end 130 of the hub 110. That is, flow traveling from forward to aft through a stage 140 is compressed while flow from aft to forward through a stage 140 is expanded. This configuration is not intended to limit the scope of the embodiments.

The shroud 150A provides a flow path between the shroud 150A and the adjacent continuous surface, i.e., the hub 110, for the inner stage 140A. The aft end 154 of the shroud is axially forward of the hub aft end 120. From this configuration, including the bell shape of the hub 110 and shroud 150A, the flow path along each of the blade stages 140 is radial at the aft end 120 of the hub 110 and axial at the forward and of the hub 110.

The hub 110 defines an axial center channel 160 for rotationally securing the hub 110 to a housing 180, discussed in greater detail below.

With the two-stage rotor 100A, the stages 140 may be configured in an ACM so that, in operation, the inner and outer stages 140A, 140B are both turbine stages. In another embodiment, the inner stage 140A is a compressor stage and outer stage 140B is a turbine stage. In another embodiment, the inner stage 140A is a turbine stage and outer stage 140B is a compressor stage.

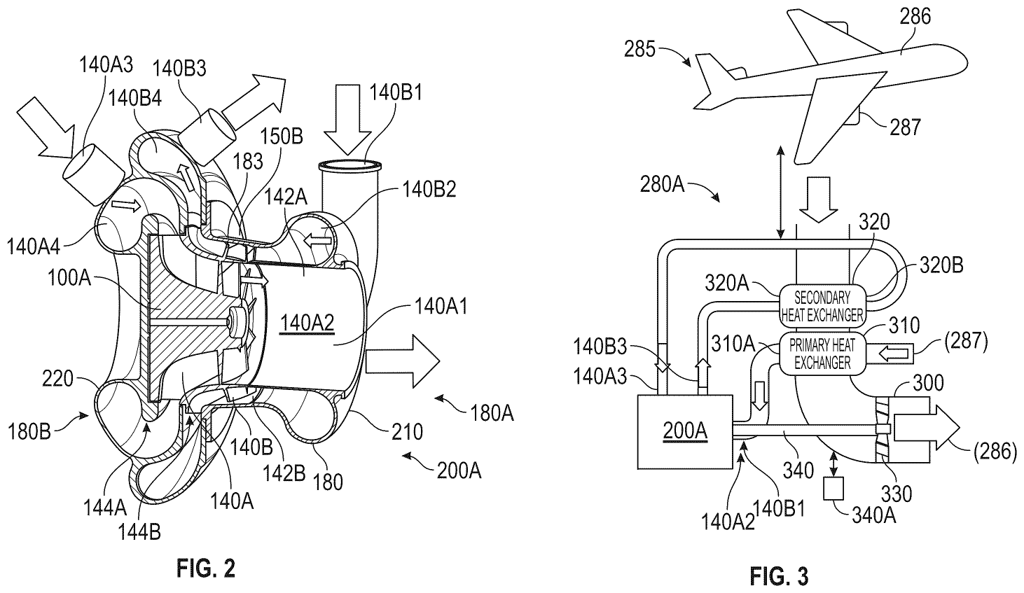

Turning to FIG. 2, a rotor assembly 200A is disclosed. The rotor assembly 200A includes the rotor 100A shown in FIG. 1A. A housing 180 encases the rotor 100A. The housing 180 extends from a forward end 180A to an aft end 180B. The housing 180 may be additively manufactured.

The housing 180 has a forward inner nozzle 140A1 and a forward inner passage 140A2 on the forward end 180A of the housing 180 that abut the forward end 142A of the inner stage 140A. A forward outer nozzle 140B1 and a forward outer passage 140B2 are defined on the forward end 180A of the housing 180 that abut the forward end 142B of the outer stage 140B.

With the flow arrows drawn in FIG. 2, the forward inner nozzle 140A1 could be referred to as the inner stage (140A) outlet. The forward inner passage 140A2 may be referred to as the inner stage (140A) outlet passage. Similarly, the forward outer nozzle 140B1 may be referred to as the outer stage (140B) inlet, with the forward outer passage 140B2 being referred to as the outer stage inlet (140B) inlet volute.

An aft inner nozzle 140A3 and an aft inner passage 140A4 are defined on the aft end 180B of the housing 180 that abut the aft end 144A of the inner stage 140A. An aft outer nozzle 140B3 and an aft outer passage 140B4 are defined on the aft end 180B of the housing 180 that abut the aft end 144B of the outer stage 140B.

With the flow arrows shown in FIG. 2, the aft inner nozzle 140A3 may be referred to as the inner stage (140A) inlet, with the aft inner passage 140A4 referred to as the inner stage (140A) inlet volute. Similarly, the aft outer nozzle 140B3 may be referred to as the outer stage (140B) outlet, with the aft end 140B4 being referred to as the outer stage (140B) outlet volute.

This configuration provides fluidly and thermally isolated flow paths into and out of the housing for each of the blade stages 140. In one embodiment, each of the passages of the housing 180 forms an annulus. As indicated, the above designations of inlet and inlet volute would switch depending on the configurations of the flow directions.

In one embodiment, a close-packed shape is defined by the passages against the housing 180. In one embodiment, one or more of the passages are layered over each other and define a non-circular cross section to obtain the close-packed shape. In one embodiment, the one or more of the passages that are layered over each other have a teardrop cross sectional shape. As shown in FIG. 2, the aft inner passage 140A4 is layered against the aft end 180B of the housing 180, the aft outer passage 140B4 is layered against the aft inner passage 140A4. The aft inner passage 140A4 and the aft outer passage 140B4 each have a teardrop cross sectional shape. The forward outer passage 140B2 is layered against the forward inner passage 140A2. This configuration and shaping of the passages provides the close-packed shape of the housing 180. The shape of these passages can vary to form not only constant cross section teardrops/toruses but also non-constant cross sections/volutes.

In one embodiment, the housing 180 is defined by a unitary forward housing portion 210 and a unitary aft portion housing portion 220. These portions 210, 220 may be fixed together, e.g., via bolting or other fixing configuration, to form the full ACM housing assembly 180. The forward housing portion 210 and covers the forward end 142 of the outer stage 140B and extends axially forward of the inner stage 140A. The forward housing portion 210 defines the forward inner nozzle 140A1, the forward inner passage 140A2, the forward outer nozzle 140B1 and the forward outer passage 140B2.

The aft housing portion 220 covers the aft end 144 of each of the blade stages 140 and the aft end of the hub 110. The aft housing portion 220 defines the aft inner nozzle 140A3, the aft inner passage 140A4, the aft outer nozzle 140B3, and the aft outer passage 140B4.

The housing portions 210, 220 overlap at an axial center of the rotor 100A to provide a fluidly sealed structure. The aft outer passage 140B4 is exterior to an aft extension 183 of the forward portion 210 of the housing 180 that fits against or forms the outer shroud 150B. As shown in the figure, in one nonlimiting embodiment, this location is where the housing portions 210, 220 may be fixed together.

Turning to FIG. 3, an air cycle machine (ACM) 280A of an aircraft 285 is disclosed. The ACM 280A may include the rotor assembly 200A shown in FIG. 2. The ACM 280A includes air conduit 300 that may receive ambient air from outside the aircraft 285 and may direct the air to a cabin 286 of the aircraft 285. Primary and secondary heat exchangers 310, 320 may be thermally coupled to the air conduit 300. The primary heat exchanger 310 may receive engine bleed air from an engine 287 of the aircraft 285.

The primary heat exchanger 310 may have an outlet 310A coupled to the forward outer nozzle 140B1 of the outer stage 140B of the rotor assembly 200A. The secondary heat exchanger 320 may have an inlet 320A coupled to the aft outer nozzle 140B3 of the outer stage 140B of the rotor assembly 200A. The secondary heat exchanger 320 may also have an outlet 320B coupled to the aft inner nozzle 140A3 of the inner stage 140A of the rotor assembly 200A. With this configuration, the outer stage 140B is a compressor stage and the inner stage 140A is a turbine stage.

A fan 330 may be disposed in the air conduit 300, downstream of the primary and secondary heat exchangers 310, 320. The forward end 130 of the hub 110 of the rotor 100A may be connected to the fan 330 via a shaft 340. In one embodiment, the shaft 340 may drive a separate machine 340A, which may drive the fan.

Turning to FIG. 4, a single shaft, one piece rotor 100B according to another embodiment is shown. In one embodiment, the rotor 100B is additively manufactured. The rotor 100B includes a hub 110 that extends from a hub aft end 120 to a hub forward end 130. The hub aft end 120 defines a first diameter D1 and the hub forward end 130 defines a second diameter D2 that is smaller than the first diameter D1.

A plurality of blade stages 140 extends from a forward end 142 to an aft end 144. The blades may be oriented axially, radially or a hybrid of each. The blade stages 140 are stacked, one on top of the other, radially outwardly from the hub 110.

The rotor 100B is a three-stage rotor 100B. The rotor 100B has an inner stage 140A that extends radially from the hub and axially from an inner stage forward end 142A to an inner stage aft end 144A. The rotor 100B also has an outer stage 140B that is radially spaced apart from the inner stage and extends axially from an outer stage forward end 142B to an outer stage aft end 144B. An intermediate stage 140C is radially between the inner and outer stages and extends from an intermediate stage forward end 142C to an intermediate stage aft end 144C.

A plurality of shrouds 150 are provided. Each one of the blade stages 140 is surrounded by a corresponding one of the shrouds 150. Thus, an inner shroud 150A surrounds the inner stage 140A, an outer shroud 150B surrounds the outer stage 140B and an intermediate shroud 150C surrounds the intermediate stage 140C. Each of the shrouds 150 extends from a forward end 152 to an aft end 154 to provide a flow path between adjacent shrouds 150 and the shrouds 150 and an adjacent continuous surface, i.e., the hub 110, for the inner stage 140A. For example, the inner shroud 150A extends from inner shroud forward to aft ends 152A, 154A, the outer shroud 150B extends from outer shroud forward to aft ends 152B, 154B, and the intermediate shroud 150C extends from intermediate shroud forward to aft ends 152C, 154C. As with the first embodiment (FIG. 1), the outer shroud 150B is optional and may be formed by the housing, discussed below.

In one embodiment, the hub 110 and shroud 150 are each thermally insulated. In one embodiment, the hub 110 and shrouds 150 are each bell shaped. In one embodiment, each of the blade stages 140 defines a flow path having a flow area that increases towards the forward end 130 of the hub 110. That is, flow from forward to aft through a stage 140 is compressed while flow from aft to forward through a stage 140 is expanded. This configuration is not intended to limit the scope of the embodiments.

The aft end 154A of the inner shroud 150A is axially forward of the hub aft end 120. The aft end 154 of each successively exterior one of the shrouds 150 is axially forward of the adjacent one of the shrouds 150. From this configuration, including the bell shape of the hub 110 and shrouds 150, the flow path along each of the blade stages 140 is radial at the aft end 120 of the hub 110 and axial at the forward and of the hub 110.

The hub 110 defines an axial center channel 160 for rotationally securing the hub 110 to a housing 180.

With the three-stage rotor 100B, the stages 140 may be configured in an ACM so that, in operation, the inner stage 140A is a compressor stage and the intermediate and outer stages 140C, 140B are both turbine stages. In another embodiment, the inner and outer stages 140A, 140B are turbine stages and the intermediate stage 140C is a compressor stage. In another embodiment, the inner and intermediate stages 140A, 140C are turbine stages and the outer stage 140B is a compressor stage.

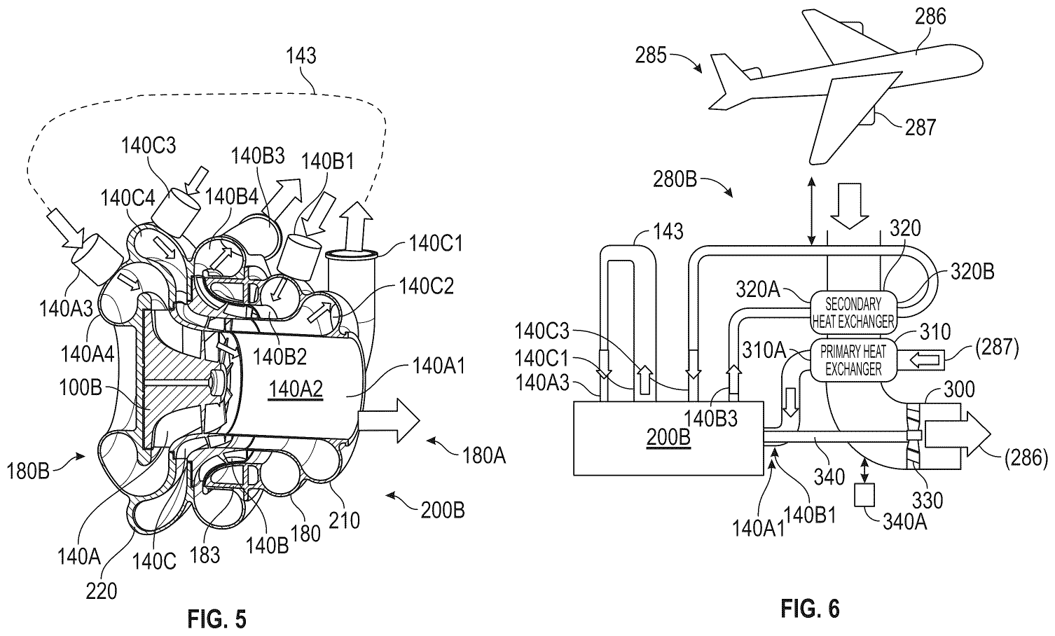

Turning to FIG. 5, a rotor assembly 200B is shown having the rotor 100B of FIG. 5. The assembly 200B includes a housing 180 in which the rotor 100B is encased. The housing 180 may be additively manufactured. The housing 180 extends from housing forward to aft ends 180A, 180B.

The forward end 180A of the housing 180 defines a forward inner nozzle 140A1 and a forward inner passage 140A2 that abuts the forward end 142B of inner stage 140A. A forward outer nozzle 140B1 and a forward outer passage 140B2 are defined on the forward end 180A of the housing 180 that abut the forward end 142B of the outer stage 140B. A forward intermediate nozzle 140C1 and a forward intermediate passage 140C2 are defined on the forward end 180A of the housing 180 that abut the forward end 142C of the intermediate stage 140C.

With the flow arrows drawn in FIG. 5, the forward inner nozzle 140A1 could be referred to as the inner stage (140A) outlet. The forward inner passage 140A2 may be referred to as the inner stage (140A) outlet passage. Similarly, the forward outer nozzle 140B1 may be referred to as the outer stage (140B) inlet, with the forward outer passage 140B2 being referred to as the outer stage inlet (140B) inlet volute. The forward intermediate nozzle 140C1 may be referred to as the intermediate stage (140C) outlet, with the forward intermediate passage 140C2 being referred to as the intermediate stage (140C) outlet passage.

The aft end 180B of the housing 180 defines an aft inner nozzle 140A3 and an aft inner passage 140A4 that abuts the aft end 144A of the inner stage 140A. An aft outer nozzle 140B3 and an aft outer passage 140B4 are defined on the aft end 180B of the housing 180 that abut the aft end 144B of the outer stage 140B. An aft intermediate nozzle 140C3 and an aft intermediate passage 140C4 are defined on the aft end 180B of the housing 180 that abut the aft end 144C of the intermediate stage 140C.

With the flow arrows shown in FIG. 5, the aft inner nozzle 140A3 may be referred to as the inner stage (140A) inlet, with the aft inner passage 140A4 referred to as the inner stage (140A) inlet volute. Similarly, the aft outer nozzle 140B3 may be referred to as the outer stage (140B) outlet, with the aft end 140B4 being referred to as the outer stage (140B) outlet volute. The aft intermediate nozzle 140C3 may be referred to as the intermediate stage (140C) inlet, with the aft end 140C4 being referred to as the intermediate stage (140C) inlet volute.

This configuration provides fluidly and thermally isolated flow paths into and out of the housing for each of the blade stages 140. In one embodiment, each of the passages of the housing 180 forms an annulus. As indicated, the above designations of inlet and inlet volute would switch depending on the configurations of the flow directions.

In one embodiment, a close-packed shape is defined by the passages against the housing 180. In one embodiment, one or more of the passages are layered over each other and define a non-circular cross section to obtain the close-packed shape. In one embodiment, the one or more of the passages that are layered over each other have a teardrop cross sectional shape. As shown in FIG. 5, the aft inner passage 140A4 is layered against the aft end 180B of the housing 180 and the aft intermediate passage 140C4 is layered against the aft inner passage 140A4. The aft inner passage 140A4 and the aft intermediate passage 140C4 each have a teardrop cross sectional shape. The forward intermediate passage 140C2 is layered against the forward inner passage 140A2, and the forward outer passage 140B2 is layered against the forward intermediate passage 140C2. The aft outer passage 140B4 is layered against the housing 180, axially between the forward outer passage 140B2 and the aft intermediate passage 140C4. This configuration and shaping of the passages provides the close-packed shape of the housing 180. The shape of these passages can vary to form not only constant cross section teardrops/toruses but also non-constant cross sections/volutes.

In one embodiment, the housing 180 is defined by a unitary forward housing portion 210 and a unitary aft portion housing portion 220. These portions 210, 220 may be fixed together, e.g., via bolting or other fixing configuration, to form the full ACM housing assembly 180. The forward housing portion 210 covers the forward end 142 of the outer stage 140B. The forward housing portion 210 extends axially forward of the inner stage 140A to define the forward inner nozzle 140A1, the forward inner passage 140A2, the forward outer nozzle 140B1, the forward outer passage 140B2, the forward intermediate nozzle 140C1 and the forward intermediate passage 140C2.

The aft housing portion 220 covers the aft end of each of the blade stages 140 and the aft end 120 of the hub 110. The aft housing portion 220 defines the aft inner nozzle 140A3, the aft inner passage 140A4, the aft outer nozzle 140B3, the aft outer passage 140B4, the aft intermediate nozzle 140C3 and the aft intermediate passage 140C4.

The housing portions 210, 220 overlap at an axial center of the rotor 100A to provide a fluidly sealed structure. The aft outer passage 140B4 is exterior to an aft extension 183 of the forward portion 210 of the housing 180 that fits against or forms the outer shroud 150B (FIG. 4). As shown in the figure, in one nonlimiting embodiment, this location is where the housing portions 210, 220 may be fixed together.

Turning to FIG. 6, an air cycle machine (ACM) 280B is shown that includes the rotor assembly 200B of FIG. 5. The ACM 280A includes air conduit 300 that may receive ambient air from outside the aircraft 285 and may direct the air to a cabin 286 of the aircraft 285. Primary and secondary heat exchangers 310, 320 may be thermally coupled to the air conduit 300. The primary heat exchanger 310 may receive engine bleed air from an engine 287 of the aircraft 285.

The primary heat exchanger 310 may have an outlet 310A coupled to the forward outer nozzle 140B1 of the outer stage 140B of the rotor assembly 200B. The secondary heat exchanger 320 may have an inlet 320A coupled to the aft outer nozzle 140B3 of the outer stage 140B of the rotor assembly 200B. The secondary heat exchanger 320 may also have an outlet 320B coupled to the aft intermediate nozzle 140C3 for the intermediate stage 140C of the rotor assembly 200B. The aft intermediate nozzle 140C3 for the intermediate stage 140C of the rotor assembly 200B may be coupled to the aft inner nozzle 140A3 of the inner stage 140A of the rotor assembly 200B, e.g. by a conduit 143. With this configuration, the outer stage 140B is configured as compressor stage and the intermediate and inner stages 140C, 140A are configured as turbine stages.

A fan 330 is disposed in the air conduit 300, downstream of the primary and secondary heat exchangers 310, 320. The forward end 130 of the hub 110 is connected to the fan 330 via a shaft 340. In one embodiment, the shaft 340 may drive a separate machine 340A, which may drive the fan.

The embodiments provide a single cast, additively manufactured, or traditionally machined ACM rotor that contains multiple separate stages within a single component. The stages are contained by intermediate shrouds that are integral to the rotor. Numerous configurations are possible so that the disclosed embodiments are not intended to limit the scope of the disclosure. The rotor defines at least one compressor and one turbine stage. The rotor may be configured to provide radial flow, mixed flow, or axial flow. The rotor may be configured with two or more different stages. Benefits of the embodiments include a reduced part count that simplifies an ACM assembly. A single rotor results in a compact ACM. The rotor may include an outer shroud, or the housing may provide that structural boundary to the outer stage.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

Those of skill in the art will appreciate that various example embodiments are shown and described herein, each having certain features in the particular embodiments, but the present disclosure is not thus limited. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description but is only limited by the scope of the appended claims.

What is claimed is:

1. A single shaft, one piece rotor comprising:
a hub that extends from a hub aft end to a hub forward end, wherein the hub aft end defines a first diameter and the hub forward end defines a second diameter that is smaller than the first diameter;
a plurality of blade stages extending from a forward end to an aft end, wherein the blade stages are stacked, one on top of the other, radially outwardly from the hub, including an inner stage that is integral with the hub and an outer stage that is radially spaced apart from the hub; and
a shroud between adjacent ones of the blade stages.

2. The rotor of claim 1, wherein the rotor is additively manufactured.

3. The rotor of claim 1, comprising
a plurality of the shrouds, wherein each one of the blade stages is surrounded by a corresponding one of the shrouds, such that there is at least an inner shroud surrounding the inner stage, and an outer shroud surrounding the outer stage.

4. The rotor of claim 3, wherein
the hub and shrouds are each bell shaped.

5. The rotor of claim 3, wherein
each of the blade stages defines a flow path having a flow area that increases towards the forward end of the hub.

6. The rotor of claim 3, wherein:
each of the shrouds extends from an aft end to a forward end;
the aft end of the inner shroud is axially forward of the hub aft end; and
the aft end of each successively exterior one of the shrouds is axially forward of the adjacent one of the shrouds,
whereby a flow path along each of the blade stages is radial at the aft end of the hub and axial at the forward and of the hub.

7. The rotor of claim 1, wherein
the hub defines an axial center channel for rotationally securing the hub to a housing.

8. A rotor assembly comprising:
the rotor of claim 1, wherein the rotor is a two-stage rotor,
wherein the inner stage extends from an inner stage forward end to an inner stage aft end and the outer stage extends from an outer stage forward end to an outer stage aft end; and
a housing in which the rotor is encased,
wherein the housing extends from a forward end to an aft end,
wherein:
the forward end of the housing defines a forward inner nozzle and a forward inner passage that abut the forward end of the inner stage, and a forward outer nozzle and a forward outer passage that abut the forward end of the outer stage; and
the aft end of the housing defines an aft inner nozzle and an aft inner passage that abut the aft end of the inner stage, and an aft outer nozzle and an aft outer passage that abut the aft end of the outer stage.

9. The rotor assembly of claim 8, wherein
the housing is defined by a unitary forward housing portion and a unitary aft portion housing portion, wherein:
the forward housing portion and covers the forward end of the outer stage, and extends axially forward of the inner stage to define: the forward inner nozzle, the forward inner passage, the forward outer nozzle, and the forward outer passage; and
the aft housing portion covers the aft end of each of the blade stages and the aft end of the hub and defines the aft inner nozzle, the aft inner passage, the aft outer nozzle, and the aft outer passage.

10. The rotor assembly of claim 8, wherein the housing is additively manufactured.

11. The rotor assembly of claim 8, wherein each of the passages of the housing defines an annulus and the passages are layered against the housing or each other to define a close-packed shape.

12. An air cycle machine including:
the rotor assembly of claim 8;
an air conduit;
primary and secondary heat exchangers coupled to the air conduit,
wherein:
the primary heat exchanger has an outlet coupled to the forward outer nozzle of the outer stage of the rotor assembly;
the secondary heat exchanger has an inlet coupled to the aft outer nozzle of the outer stage of the rotor assembly, and an outlet coupled to the aft inner nozzle of the inner stage of the rotor assembly,
whereby the outer stage is a compressor stage and the inner stage is a turbine stage.

13. The air cycle machine of claim 12, comprising
a fan disposed in the air conduit, downstream of the primary and secondary heat exchangers, wherein the forward end of the hub is connected to the fan via a shaft.

14. A rotor assembly comprising:
the rotor of claim 1, wherein the rotor is a three-stage rotor having:
the inner stage that extends from an inner stage forward end to an inner stage aft end, the outer stage that extends from an outer stage forward end to an outer stage aft end, and an intermediate stage that extends from an intermediate stage forward end to an intermediate stage aft end; and
the shroud is an inner shroud surrounding the inner stage, and an intermediate shroud surrounds the intermediate stage; and
wherein the assembly includes:
a housing in which the rotor is encased,
wherein the housing extends from a forward end to an aft end, wherein:
the forward end defines a forward inner nozzle and a forward inner passage that abut the forward end of the inner stage, a forward outer nozzle and a forward outer passage that abut the forward end of the outer stage, and a forward intermediate nozzle and a forward intermediate passage that abut the forward end of the intermediate stage; and
the aft end defines an aft inner nozzle and an aft inner passage that abut the aft end of the inner stage, an aft outer nozzle and an aft outer passage that abut the aft end of the outer stage, and an aft intermediate nozzle and an aft intermediate passage that abut the aft end of the intermediate stage.

15. The rotor assembly of claim 14, wherein:
the housing is defined by a unitary forward housing portion and a unitary aft portion housing portion;
the forward housing portion covers the forward end of the outer stage, and extends axially forward of the inner stage to define the forward inner nozzle, the forward inner passage, the forward outer nozzle, the forward outer passage, the forward intermediate nozzle, and the forward intermediate passage; and
the aft housing portion covers the aft end of each of the blade stages and the aft end of the hub and defines the aft inner nozzle, the aft inner passage, the aft outer nozzle, the aft outer passage, the aft intermediate nozzle, and the aft intermediate passage.

16. The rotor assembly of claim 14, wherein the housing is additively manufactured, and the passages are positioned against the housing to define a close-packed shape.

17. The rotor assembly of claim 1, wherein each of the passages of the housing defines an annulus and the passages are layered against the housing or each other to define a close-packed shape.

18. An air cycle machine including:
the rotor assembly of claim 14;
an air conduit;
primary and secondary heat exchangers coupled to the air conduit,
wherein:
the primary heat exchanger has an outlet coupled to the forward outer nozzle of the outer stage of the rotor assembly; and
the secondary heat exchanger has: an inlet coupled to the aft outer nozzle of the outer stage of the rotor assembly; and an outlet coupled to the aft intermediate nozzle of the intermediate stage of the rotor assembly,
wherein the forward intermediate nozzle for the intermediate stage of the rotor assembly is coupled to the aft inner nozzle of the inner stage of the rotor assembly,
whereby the outer stage is a compressor stage and the intermediate and inner stages are turbine stages.

19. The air cycle machine of claim 18, comprising
a fan disposed in the air conduit, downstream of the primary and secondary heat exchangers, wherein the forward end of the hub is connected to the fan via a shaft.

20. The rotor of claim 1, wherein:
the rotor is a two stage rotor that includes the inner and outer stages, wherein: the inner and outer stages are turbine stages; or the inner stage is a compressor stage and the outer stage is a turbine stage; or the inner stage is the turbine stage and the outer stage is the compressor stage; or
the rotor is a three stage rotor that includes the inner and outer stages and an intermediate stage, wherein: the inner stage is the compressor stage and the intermediate and outer stages are the turbine stages; or the inner and outer stages are the turbine stages and the intermediate stage is the compressor stage; or the inner and intermediate stages are the turbine stages and the outer stage is the compressor stage.
